(19) United States
(12) Patent Application Publication
(10) Pub. No.: US 2021/0312509 A1
(43) Pub. Date: Oct. 7, 2021

(54) System and Method for Remote Valuation and Resale of a Used Electronic Device

(71) Applicant: Tu Nguyen, Fremont, CA (US)

(72) Inventor: Tu Nguyen, Fremont, CA (US)

(21) Appl. No.: 14/800,623

(22) Filed: Jul. 15, 2015

Related U.S. Application Data
(63) Continuation-in-part of application No. 14/477,794, filed on Sep. 4, 2014, now abandoned.
(60) Provisional application No. 62/024,982, filed on Jul. 15, 2014.

(51) Int. Cl. G06Q 30/02; G06Q 30/00; G06Q 30/06; G06F 16/953

(52) U.S. Cl. CPC G06Q 30/0278; G06Q 30/018; G06F 8/61; G06Q 30/0206; G06F 16/953; G06Q 30/0611

(57) ABSTRACT

A method for determining and continuously updating the price of a used electronic device and for enabling the consumer to easily resell the used electronic device when desired.

### CROSS-REFERENCE TO RELATED APPLICATIONS

The present application takes priority from Provisional Application No. 62/024,982, filed Jul. 15, 2014, which is herein incorporated by reference, and is a continuation-in-part of application Ser. No. 14/477,794, filed Sep. 4, 2014.

### STATEMENT REGARDING FEDERALLY SPONSORED RESEARCH AND DEVELOPMENT

Not applicable.

### BACKGROUND

### Field of the Invention

The present invention relates generally to the valuation and resale of used electronic devices, and more particularly to the valuation and resale of a used electronic device by use of an app installed on the electronic device itself.

### Description of the Related Art

Electronic devices such as smartphones, mp3 players, tablets, and other similar devices, are very frequently upgraded. As a result, many consumers have used electronic devices cluttering up their home. However, the typical consumer is unaware of the value they could realize by reselling their device, and of where or how they could resell it. At present, the way to resell a used electronic device is by driving to the cell phone provider or resale facility, waiting while the device is evaluated, and only then finding out how much the device is worth. Often, the value is too small to justify the trip.

A need exists for a system and method of valuation of a used electronic device that enables a consumer to find out how much the device is worth without going anywhere.

### SUMMARY OF THE INVENTION

An object of the present invention is to allow a consumer to easily see a potential resale value for their electronic device without any unnecessary time or effort.

Another object of the present invention is to allow a consumer to easily sell their electronic device when desired.

For purposes of this description, an “electronic device” is a smartphone, mp3 player, cell phone, laptop, tablet, gaming device, or any other device that can connect to the Internet and download and run applications.

The method of the present invention comprises installing a first app on the electronic device, wherein the first app identifies the device and searches at least one database for resale values for devices similar to the electronic device. The database may be located on a server, a website, or both. Once the first app is done searching, it determines an approximate resale value for the electronic device and displays it for the consumer. The consumer is given the option to decide to sell the device; if the consumer decides to sell the device, a second app is installed on the electronic device. The second app performs an evaluation of the electronic device and sends the evaluation results to at least one reseller.

In an embodiment, the evaluation performed by the second app comprises a functional test. The functional test can test any function of the electronic device, such as the battery, camera, buttons, touchscreen, display, wi-fi connection, cellular connection, Bluetooth connection, microphone, speaker, biometric scanner, NFC function, processor, memory, light sensor, GPS function, gyroscope, barometer, headphone jack, or infrared transmitter.

In an embodiment, the evaluation performed by the second app comprises a cosmetic test. The cosmetic test may be simply directing the user to pick a cosmetic condition for their electronic device, or may comprise directing the user to take a photo of the electronic device using the electronic device's own camera and a reflective surface. The photo is then evaluated to determine the electronic device's cosmetic condition.

In searching for prices, the first app may search at least one proprietary website belonging to a reseller.

The first app may perform the steps of searching for prices and determining an approximate resale price for the electronic device repeatedly, preferably daily.

The step of determining an approximate resale price for the electronic device may comprise finding at least two resale values for similar electronic devices and calculating the average of these values, finding at least two resale values for similar electronic devices and displaying the highest value, or displaying all of the resale values found.

The first app may also display past resale values for the consumer in addition to the present resale value. In an embodiment, a graph of past resale values may be shown to the consumer.

The first app may also calculate future projected resale values and display those for the consumer.

### LIST OF FIGURES

FIG. 1 shows a flowchart of the operation of the Provisioned App of the preferred embodiment of the present invention.

FIG. 2 shows a flowchart of the operation of the Evaluation App of the preferred embodiment of the present invention.

### DETAILED DESCRIPTION OF THE PREFERRED EMBODIMENT

The preferred embodiment comprises the installation of two apps on the electronic device to be resold (referred to in the present disclosure as the “device” or the “electronic device”). Preferably, the first app is provisioned with the device when the device is originally sold as a new device to the consumer (the “Provisioned App”). The second app is installed only after the consumer decides to resell the device (the “Evaluation App”). Both of the apps preferably are written for multiple operating systems such as iOS, Android, and so on.

In the preferred embodiment, the role of the Provisioned App is simply to alert the consumer what their device is likely to sell for if they were to sell it right now, to give the consumer the choice to sell their device when they wish to do so, to load and run the Evaluation App to determine the device's condition and offering price, and to process the sale. The role of the Evaluation App is to evaluate the functional and cosmetic condition of the device and to provide that information to the Provisioned App.

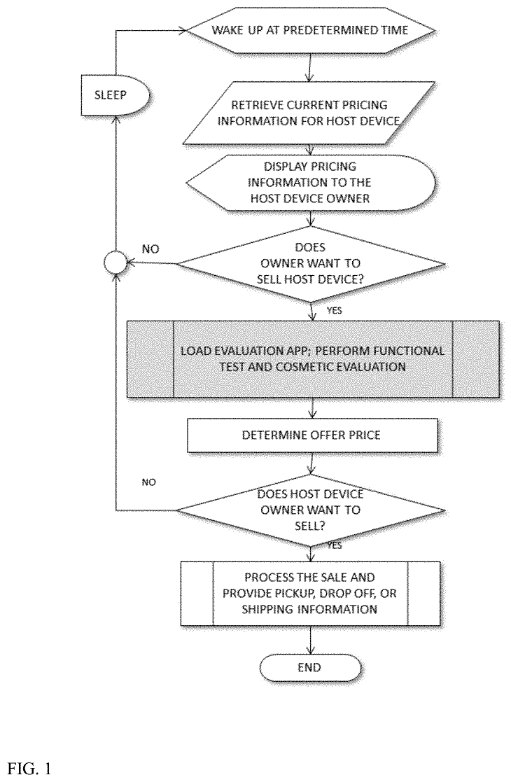

FIG. 1 shows a flow chart of the Provisioned App. Prior to starting the flowchart, the Provisioned App identifies the device on which it is installed. This identification can comprise determining the device type, device ID, operating system type and version, service provider, and any other information that could be relevant to a reseller for selling the device. The Provisioned App obtains this information by querying the device when it is first run, or the information may be programmed into the Provisioned App when the device is first provisioned at the factory. In the preferred embodiment, the Provisioned App is installed on the device when it is provisioned at the factory. The identification step preferably happens prior to the consumer's use of the device.

The Provisioned App then is triggered to wake up at predetermined intervals—preferably daily. The intervals can also be weekly, monthly, or at any other regular or irregular intervals. This is preferably accomplished by a simple time-driven trigger tied to the clock of the electronic device.

When the Provisioned App wakes up, it searches predetermined mobile device reseller websites, proprietary databases, servers, or any other sources of resale pricing information for resale prices of devices similar to the electronic device. The particular websites, databases, and servers may be pre-set upon provisioning, or may be customized by the user. Some non-limiting examples of websites the Provisioned App may search are Amazon, eBay, and Gazelle. The Provisioned App preferably performs its search by doing a simple web crawl, but may also access proprietary databases belonging to a particular reseller.

After the Provisioned App performs its search, it displays pricing information to the user. The pricing information may be displayed in multiple ways in multiple embodiments of the present invention. For example, the Provisioned App may display all the prices obtained by doing the search, may display an average of all the prices, may display the highest price, or the highest and lowest price. The pricing information may be displayed inside the app when the user runs the app, or as a push notification for the user.

In an embodiment, the Provisioned App may also display past pricing information for similar devices, to give the user an idea of how fast the prices of similar devices are changing. For example, the Provisioned App may display a graph showing the resale price for similar devices over time, or simply a sequence of prices as textual information.

In an embodiment, the Provisioned App may also display projected future prices for the device. The projected future prices may be displayed as a graph, or simply as textual information. The projection may be calculated by any known methods of statistical analysis.

The Provisioned App may send the user a push notification when the resale price reaches a particular value. For example, the user may receive a push notification saying “Your device is now worth $99; sell now?” The Provisioned App may also give the user a projected future date at which the resale price reaches a particular value.

When the Provisioned App displays the pricing information, it preferably also gives the user the option to decide to sell the device. This is preferably accomplished with a “SELL NOW” button displayed on the pricing information screen, but may also be accomplished by any other way that gives the user the option to indicate their desire to sell the device at that particular moment.

Once the consumer decides to sell the device, they are directed to a URL belonging to a particular reseller from which they can download an Evaluation App onto the device. The reseller may be pre-selected when the Provisioned App is installed at the factory, or may be selected by the user later. In the preferred embodiment, the reseller is pre-selected when the Provisioned App is first installed.

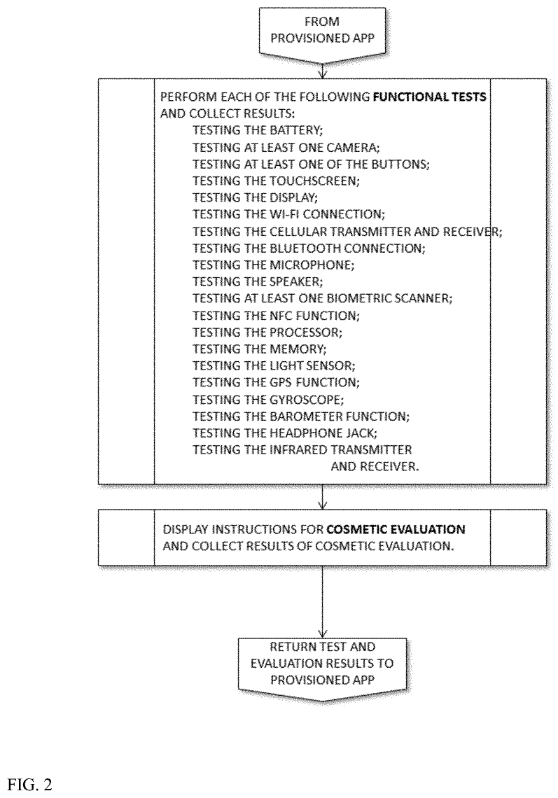

FIG. 2 shows a flowchart showing the operation of the Evaluation App. After the user downloads and installs the Evaluation App as directed by the Provisioned App, the Evaluation App performs various tests on the device. In the preferred embodiment, as shown in the Figure, it first performs a series of functional tests on the device. Some of these tests can be performed automatically without the user's involvement. Some of the tests, such as the button test and the touchscreen test, require the user to interact with the device in order for the test to be performed.

After performing the functional tests, the Evaluation App then displays instructions for the user to perform a cosmetic evaluation of the device. The cosmetic evaluation is intended to determine the cosmetic condition of the device—for example, how many scratches, scuff marks, and cracks it has. In the preferred embodiment, the user is directed to place the device in front of a mirror and to take a photo of the device with the device's own camera, first front and then back. The two resulting photos are then analyzed to determine the number of cosmetic imperfections on the device and therefore its cosmetic condition. The analysis may be performed by the Evaluation App, or the photos may be simply provided to the reseller. In another embodiment, the user is simply directed to enter the device's cosmetic condition into the app—for example as “New”, “Used”, and “Broken”.

After the functional and cosmetic tests are performed, the Evaluation App compiles the test results into a report. The report preferably contains information on each function of the device, as well as information on its cosmetic condition (or simply the photos).

In an embodiment, the Evaluation App also detects if theft-prevention software such as Find My iPhone is running. If it is, the consumer is directed to disable that software prior to reselling the device. The Evaluation App preferably detects the presence of theft-prevention software by querying the device for information that it can only provide if theft-prevention software is not running; if the device cannot provide this information, the Evaluation App concludes that theft-prevention software is turned on.

The results of the functional and cosmetic evaluations, along with the device ID, the make/model/age of the device, and other information, are then sent back to the reseller by the Evaluation App. The reseller then has a record of the device and its condition. If the condition of the device roughly matches what the consumer indicated in the Provisioned App, the reseller confirms the price offer. If the condition of the device is different from what the consumer indicated in the Provisioned App, the reseller makes a different price offer to the consumer. The consumer is then directed to accept or reject the offer.

In an embodiment, once the consumer accepts the price offer, all data on the device is erased. The consumer can then see that their data has been erased, which will allay any security concerns.

After the price offer is accepted, the consumer needs to deliver the device to the reseller and to receive payment for their device. The delivery can happen by mail, by dropping off the device at an automated kiosk located in a public place, or by a courier service picking up the device at the consumer's location.

If the consumer drops off the device at an automated kiosk, the consumer can get paid through the kiosk. If the device is picked up by a courier service, the courier can deliver the payment. If the device is mailed off by the consumer, the payment can be made by mail or online. Other delivery methods and payment methods may also be used with the present invention.

Exemplary embodiments have been described above. It will, however, be clear to a person of reasonable skill that the invention encompasses other embodiments, which also fall into the scope of the present invention.

1. A method for remote valuation and resale of an electronic device, comprising:
installing a first application on the electronic device;
using the first application to identify the electronic device;
using the first application to search at least one database for resale values for devices similar to the electronic device;
using the first application to determine an approximate resale value for the electronic device;
using the first application to display the approximate resale value to the consumer;
directing the consumer to indicate their desire to sell the electronic device;
if the consumer decides to sell the device, installing a second application on the electronic device;
using the second application to perform an evaluation of the electronic device;
using the second application to detect whether or not theft-prevention software is installed on the electronic device;
using the second application to record the evaluation results;
sending the evaluation results to a reseller.

2. The method of claim 1, where the at least one database is located on a reseller website.

3. The method of claim 1, where the at least one database is located on a server.

4. The method of claim 1, wherein the evaluation of the electronic device comprises at least one of the following:
performing a functional test;
performing a cosmetic test.

5. The method of claim 2, wherein the functional test comprises testing at least one of the following functions of the electronic device:
testing the battery of the electronic device;
testing at least one camera of the electronic device;
testing at least one of the buttons of the electronic device;
testing the touchscreen of the electronic device;
testing the display of the electronic device;
testing the wi-fi connection of the electronic device;
testing the cellular transmitter and receiver of the electronic device;
testing the Bluetooth connection of the electronic device;
testing the microphone of the electronic device;
testing the speaker of the electronic device;
testing at least one biometric scanner of the electronic device;
testing the NFC function of the electronic device;
testing the processor of the electronic device;
testing the memory of the electronic device;
testing the light sensor of the electronic device;
testing the GPS function of the electronic device;
testing the gyroscope of the electronic device;
testing the barometer function of the electronic device;
testing the headphone jack of the electronic device;
testing the infrared transmitter and receiver of the electronic device.

6. The method of claim 2, wherein the cosmetic test comprises:
displaying instructions for a cosmetic evaluation on the electronic device;
receiving information regarding the device under test's cosmetic condition via the electronic device.

7. The method of claim 2, wherein the cosmetic test comprises:
displaying instructions for taking at least one photograph of the electronic device using the electronic device's own camera and a reflective surface;
receiving at least one photograph of the electronic device;
analyzing the at least one photograph.

8. The method of claim 1, wherein the step of using the first application to search at least one reseller website for resale values for devices similar to the electronic device comprises searching at least one proprietary website belonging to a reseller.

9. The method of claim 1, wherein the following steps are performed repeatedly:
using the first application to search at least one reseller website for resale values for devices similar to the electronic device;
using the first application to determine an approximate resale value for the electronic device;
using the first application to display the approximate resale value to the consumer;
directing the consumer to indicate their desire to sell the electronic device.

10. The method of claim 8, wherein the steps that are performed repeatedly are performed daily.

11. The method of claim 1, wherein the step of determining an approximate resale value for the electronic device comprises:
finding at least two resale values for devices similar to the electronic device;
calculating the average of the at least two resale values.

12. The method of claim 1, wherein the step of determining an approximate resale value for the electronic device comprises:
finding at least two resale values for devices similar to the electronic device;
determining the highest value of the at least two resale values.

13. The method of claim 1, wherein the step of determining an approximate resale value for the electronic device comprises:
finding at least two resale values for devices similar to the electronic device;
displaying the at least two resale values.

14. The method of claim 1, further comprising:
using the first application to display at least one past approximate resale value to the consumer.

15. The method of claim 1, further comprising:
using the first application to calculate at least one projected future value;
using the first application to display at least one projected future value to the consumer.
